(19) United States
(12) Patent Application Publication
(10) Pub. No.: US 2017/0292441 A1
(43) Pub. Date: Oct. 12, 2017

(54) DEVICE FOR VARIABLY CONTROLLING FLOW RATE OF INTAKE AIR OF TURBOCHARGER COMPRESSOR

(71) Applicant: HYUNDAI MOTOR COMPANY, Seoul (KR)

(72) Inventor: Young Soo Jin, Suwon-si (KR)

(73) Assignee: HYUNDAI MOTOR COMPANY, Seoul (KR)

(21) Appl. No.: 15/286,181

(22) Filed: Oct. 5, 2016

(30) Foreign Application Priority Data
Apr. 11, 2016 (KR) 10-2016-0043900

(51) Int. Cl. F02B 37/16

(52) U.S. Cl. CPC F02B 37/16; F02B 2037/162

(57) ABSTRACT

The present disclosure provides a device for variably controlling a flow rate of intake air of a turbocharger compressor including a housing, a compressor wheel, a sliding insert disposed in a straight tube in the housing coaxially with the straight tube, wherein the sliding insert variably adjusts an intake air recirculation passageway while moving closer to or farther from the straight tube in an axial direction, and a drive unit which provides power for moving the sliding insert, such that efficiency of the compressor may be improved because a flow rate of intake air is increased as the intake air is recirculated, and performance of an engine may be improved by improving performance of a turbocharger because an air amount required for the engine may be controlled by means of a variable slit structure.

### CROSS-REFERENCE TO RELATED APPLICATION

This application claims priority to and the benefit of Korean Patent Application No. 10-2016-0043900, filed on Apr. 11, 2016, the entire contents of which are incorporated herein by reference.

### FIELD

The present disclosure relates to a device for variably controlling a flow rate of intake air of a turbocharger compressor. More particularly, it relates to a device for variably controlling a flow rate of intake air of a turbocharger.

### BACKGROUND

The statements in this section merely provide background information related to the present disclosure and may not constitute prior art.

In general, a turbocharger is a device which increases output of an engine of a vehicle by supercharging a cylinder of the engine with inflow air by rotating a turbine wheel and a compressor wheel by using high-temperature and high-pressure energy of exhaust gas being discharged from the engine.

Usually, a commercially available diesel engine employs an intake air recirculation compressor housing which is typically applied to improve performance of the turbocharger compressor.

Some intake air recirculation compressor housings, which are commercially available, include a slit for recirculating intake air, and the slit is provided in a form of a predetermined gap in the housing made of an aluminum material.

For example, as illustrated in FIG. 5, the intake air recirculation compressor housing includes a compressor housing 10 for guiding intake air and discharge air, and a compressor wheel 11 for introducing air, and a slit 13 for recirculating intake air is formed in a straight tube 12 in the compressor housing 10 along a circumference of a front end portion of the compressor wheel 11.

Therefore, low-compressed and high-flow-rate intake air (air flow stabilization) is provided as air flows in a forward direction through the slit under a chock condition, and high-compressed and low-flow-rate intake air is provided as the intake air is recirculated when air flows in a reverse direction through the slit under a surge condition as indicated by arrows, thereby improving performance by expanding an operation region of the compressor.

However, we have found that because a gap of the slit formed in the current intake air recirculation compressor housing is about 3 to 4 mm, and thus an area of an intake air recirculation passageway is fixed, there is a limitation in improving performance of the compressor.

The above information disclosed in this Background section is only for enhancement of understanding of the background of the disclosure and therefore it may contain information that does not form the prior art that is already known to a person of ordinary skill in the art.

Further areas of applicability will become apparent from the description provided herein. It should be understood that the description and specific examples are intended for purposes of illustration only and are not intended to limit the scope of the present disclosure.

### SUMMARY

The present disclosure provides a device for variably controlling a flow rate of intake air of a turbocharger compressor to adjust an area of an intake air recirculation passageway applied to recirculate intake air in an intake air recirculation compressor housing of a commercially available diesel engine, such that efficiency of the compressor may be improved because a flow rate of intake air is increased as the intake air is recirculated, and performance of an engine may be improved by improving performance of a turbocharger because an air amount required for the engine may be controlled by means of a variable slit structure.

In one form, the present disclosure provides a device for variably controlling a flow rate of intake air of a turbocharger compressor, the device including: a compressor housing which guides intake air and discharge air; a compressor wheel for air intake; a sliding insert which is disposed in a straight tube in the compressor housing coaxially with the straight tube, and variably adjusts an intake air recirculation passageway while moving forward and rearward in an axial direction; and a drive unit which provides power for operating the sliding insert.

In one form, the drive unit may include: an actuator which generates power; a rod-lever assembly which is connected to a rod of the actuator and rotatable; and a pinion gear which is mounted on the rod-lever assembly and moves the sliding insert.

In another form, the pinion gear of the drive unit may be connected to and mesh with a rack gear disposed on the sliding insert and may move the sliding insert by means of a rack-and-pinion mechanism.

In still another form, the actuator of the drive unit may be configured as a constant-pressure diaphragm type actuator.

In yet another form, the sliding insert may be guided by being in contact with an inner wall of the straight tube by using a plurality of guide protrusions formed on an outer circumferential surface thereof when the sliding insert is moved.

In still yet another form, the intake air recirculation passageway, which is changed in accordance with the movement of the sliding insert, may be formed in the form of a gap formed between an insert side inclined surface and a straight tube side inclined surface, and the gap formed between the insert side inclined surface and the straight tube side inclined surface may be structured to be inclined from a center to an outer periphery toward a front side where intake air inflows. The gap formed between the insert side inclined surface may be structured to be inclined from a center of the sliding insert to an outer periphery of the sliding insert toward a front side of the device where intake air inflows, and the straight tube side inclined surface may be structured to be inclined from a center of the straight tube to an outer periphery of the straight tube toward the front side of the device where intake air inflows.

The device for variably controlling a flow rate of intake air of a turbocharger compressor, which is provided by the present disclosure, has at least the following advantages.

First, an area of the intake air recirculation slit is variably expanded in the compressor housing of the turbocharger, such that it is possible to improve performance of the turbocharger by increasing the amount of intake air, and as a result, it is possible to improve performance of an engine and marketability of the engine.

Second, with a structure that greatly expands an operation region, particularly, a surge region of the turbocharger compressor, it is possible to expand the surge region in the event of a surge phenomenon that instantaneously occurs when an accelerator pedal is pressed and then released, and as a result, it is possible to eliminate surge noise.

It is understood that the term “vehicle” or “vehicular” or other similar terms as used herein are inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuel derived from resources other than petroleum). As referred to herein, a hybrid vehicle is a vehicle that has two or more sources of power, for example both gasoline-powered and electric-powered vehicles.

Further areas of applicability will become apparent from the description provided herein. It should be understood that the description and specific examples are intended for purposes of illustration only and are not intended to limit the scope of the present disclosure.

### DRAWINGS

The above and other features of the present disclosure will now be described in detail with reference to various forms thereof illustrated in the accompanying drawings, in which:

FIG. 1 is a perspective view illustrating a device for variably controlling a flow rate of intake air of a turbocharger compressor according to one form of the present disclosure;

FIG. 2 is a perspective view illustrating a state in which respective components of the device for variably controlling a flow rate of intake air of a turbocharger compressor according to one form of the present disclosure are disassembled;

FIG. 3 is a cross-sectional view illustrating a narrow slit gap position and a state in which the device for variably controlling a flow rate of intake air of a turbocharger compressor according to one form of the present disclosure is operated;

FIG. 4 is a cross-sectional view illustrating a wide slit gap position and a state in which the device for variably controlling a flow rate of intake air of a turbocharger compressor according to one form of the present disclosure is operated; and

FIG. 5 is a front view and a cross-sectional view illustrating a typical intake air recirculation compressor housing.

The drawings described herein are for illustration purposes only and are not intended to limit the scope of the present disclosure in any way.

Reference numerals set forth in the Drawings include reference to the following elements as further discussed below:

10: compressor housing

11: compressor wheel

12: straight tube

13: intake air recirculation passageway

14: sliding insert

15: drive unit

16: actuator

17: rod-lever assembly

17a: lever portion

17b: rod portion

18: pinion gear

19: rack gear

20: guide protrusion

21: insert side inclined surface

22: straight tube side inclined surface

23: hose

24: bushing

25: gear housing

26: opening

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

While the disclosure will be described in conjunction with various forms of the present disclosure, it will be understood that present description is not intended to limit the disclosure to forms. On the contrary, the disclosure is intended to cover various alternatives, modifications, equivalents and other forms, which may be included within the spirit and scope of the disclosure as defined by the present disclosure.

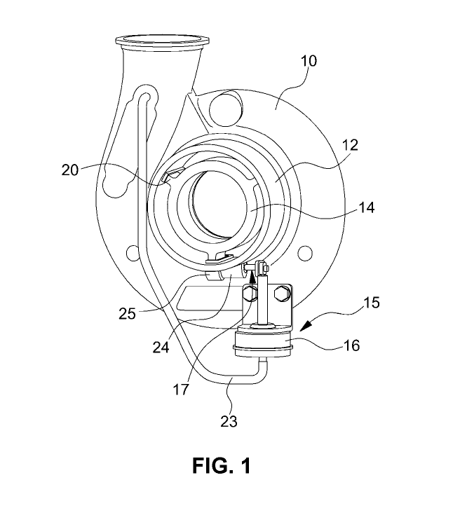

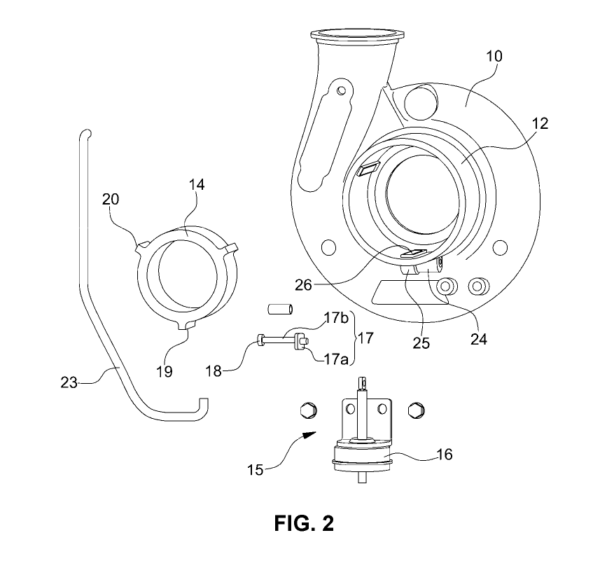

FIG. 1 is a perspective view illustrating a device for variably controlling a flow rate of intake air of a turbocharger compressor according to one form of the present disclosure, and FIG. 2 is a perspective view illustrating a state in which respective components of the device for variably controlling a flow rate of intake air of a turbocharger compressor according to one form of the present disclosure are disassembled.

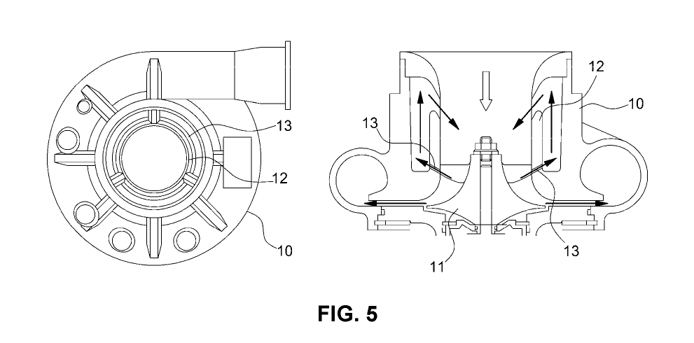

As illustrated in FIGS. 1 and 2, the device for variably controlling a flow rate of intake air of a turbocharger compressor includes a compressor housing 10 which has a straight tube 12 into which outside air flows, and a compressor wheel (designated by reference numeral 11 in FIG. 5) which is positioned in the compressor housing 10, for example, at an immediate rear side of the straight tube 12 and sucks air.

Therefore, air, which inflows through the straight tube 12 when the compressor wheel 11 is rotated, may be discharged to an engine along a passageway in the compressor housing 10.

Here, because shapes of the compressor housing 10 and the compressor wheel 11 and a structure in which the compressor housing 10 and the compressor wheel 11 are coupled are similar to those of a typical intake air recirculation compressor housing, specific descriptions thereof will be omitted.

The device for variably controlling a flow rate of intake air of a turbocharger compressor includes a sliding insert 14 which serves as a means for changing an area of an intake air recirculation passageway.

The sliding insert 14 has a circular tube shape, and is disposed in the straight tube 12 coaxially with the straight tube 12 and installed to be slidable forward and rearward in an axial direction of the straight tube 12.

That is, a plurality of guide protrusions 20 is formed to protrude from an outer circumferential surface of the sliding insert 14 so as to be parallel with each other in a longitudinal direction and disposed in a circumferential direction at predetermined intervals. For example, as shown in FIG. 2, three guide protrusions 20 are disposed in the circumferential direction at an interval of approximately 120°, and the sliding insert 14 is guided by the straight tube 12 by means of the guide protrusions 20 when the sliding insert 14 slides forward and rearward in a state in which the sliding insert 14 is in contact with and engages an inner wall of the straight tube 12.

A rack gear 19 is formed at one side of the outer circumferential surface of the sliding insert 14, for example, on a surface of any one guide protrusion 20 among the plurality of guide protrusions 20, and the rack gear 19 is engaged with a pinion gear 18 to be described below, such that the sliding insert 14 may slide forward and rearward by the rack-and-pinion mechanism.

In particular, with the forward and rearward sliding operation of the sliding insert 14, an intake air recirculation passageway 13, that is, a slit may be variably adjusted.

To this end, the intake air recirculation passageway 13 is formed between a circumferential surface of a rear end portion of the sliding insert 14 and an inner circumferential surface of a rear end portion of the straight tube 12 which faces the rear end portion of the sliding insert 14.

That is, the intake air recirculation passageway 13 is formed in the form of a gap formed between an insert side inclined surface 21 formed at the circumferential surface of the rear end portion of the sliding insert 14 and a straight tube side inclined surface 22 formed at the inner circumferential surface of the rear end portion of the straight tube 12.

In this case, the gap formed between the insert side inclined surface 21 and the straight tube side inclined surface 22 may be structured to be inclined from a center to an outer periphery toward a front side where the intake air inflows.

Therefore, a part of the intake air, which inflows through the straight tube 12, may be discharged and flow forward through the intake air recirculation passageway 13 formed between the insert side inclined surface 21 and the straight tube side inclined surface 22, and then flow back into the straight tube 12.

The device for variably controlling a flow rate of intake air of a turbocharger compressor includes a drive unit 15 as a means for moving the sliding insert 14 forward and rearward.

The drive unit 15 includes an actuator 16 which generates power, a rod-lever assembly 17 which is connected to a rod of the actuator 16 and rotatable, and the pinion gear 18 which is mounted on the rod-lever assembly 17 and moves the sliding insert 14.

Here, the actuator 16 may be a constant-pressure diaphragm type actuator, and a hose 23, which supplies pressure from an outlet of the compressor, is connected to the actuator 16.

The rod-lever assembly 17 includes a lever portion 17a which is connected to the rod of the actuator, and a rod portion 17b which has the pinion gear 18 mounted at a tip thereof, and is connected to the lever portion 17a at a rear end thereof.

The rod-lever assembly 17 is, by means of the rod portion 17b, penetratively fastened to a bushing 24 installed on a front surface of the compressor housing 10, and in this case, the rod-lever assembly 17 is freely rotatable around the rod portion 17b.

The pinion gear 18 at the tip of the rod portion of the rod-lever assembly 17, which is installed as described above, is placed in a gear housing 25 formed at one side of the outer circumference of the straight tube 12, and in this state, gear teeth of the pinion gear 18 are exposed through an opening 26 of the gear housing 25, such that the pinion gear 18 may be engaged with the rack gear 19 formed on the sliding insert 14.

In this case, an actuator rod side connecting portion of the lever portion 17a of the rod-lever assembly 17 is eccentric to the rod portion 17b, and as a result, rectilinear motion of the actuator 16 may be converted into rotational motion of the rod portion 17b and the pinion gear 18.

Therefore, an operation of the device for variably controlling a flow rate of intake air of a turbocharger compressor, which is configured as described above, will be described below.

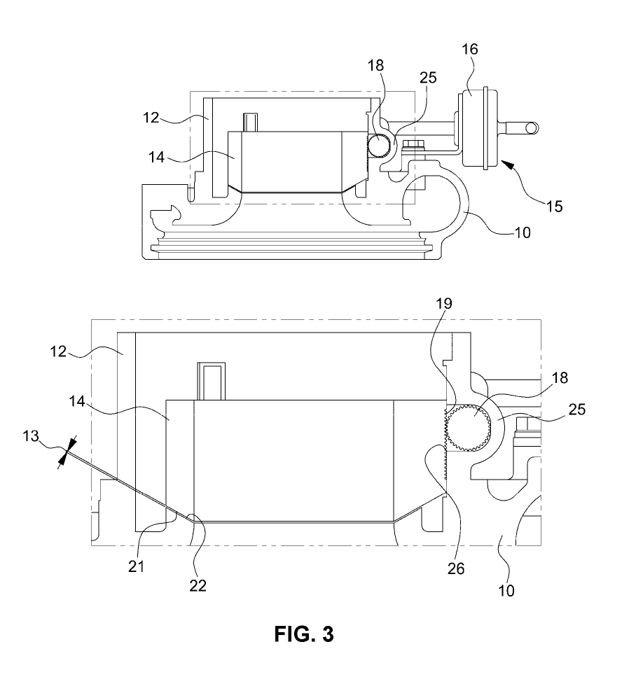

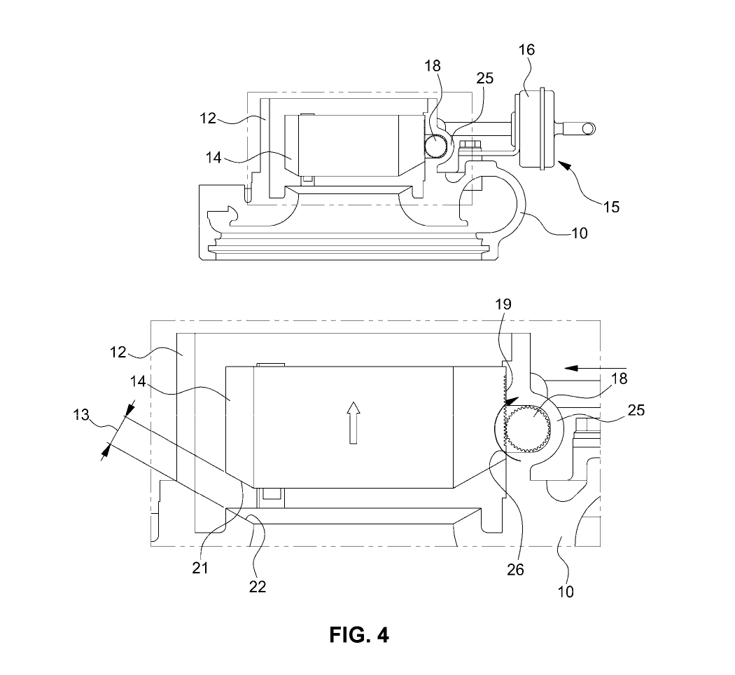

FIGS. 3 and 4 are cross-sectional views illustrating states in which the device for variably controlling a flow rate of intake air of a turbocharger compressor according to one form of the present disclosure is operated, and illustrating a narrow slit gap position and a wide slit gap position, respectively.

As illustrated in FIGS. 3 and 4, the device for variably controlling a flow rate of intake air of a turbocharger compressor adjusts a gap of the slit (intake air recirculation passageway) by moving a position of the sliding insert 14.

According to an operational mechanism, the gap of the slit may be adjusted through processes of transmitting pressure from the outlet of the compressor, operating the rod of the actuator 16, rotating the rod-lever assembly 17, rotating the pinion gear 18 connected to the rod-lever assembly 17, and moving a position of the sliding insert 14.

That is, the gap of the slit is increased when pressure is supplied to the actuator, and the gap of the slit is decreased when pressure is not supplied to the actuator.

Here, the actuator 16 is operated over tension of a spring which is initially set in accordance with tension of the constant-pressure diaphragm type spring.

An initial position of the sliding insert 14 is set such that the gap of the slit is about 3 to 4 mm which is similar to the gap of the existing fixed type intake air recirculation compressor housing, and the sliding insert 14 is operated in a direction in which the gap of the slit is increased.

Therefore, the effect of the device for variably controlling a flow rate of intake air of a turbocharger compressor according to the present disclosure is increased in a surge region where a flow rate of intake air is insufficient and pressure is high at the outlet of the compressor.

In a case in which pressure is high at the outlet of the compressor, the gap of the slit is further increased, and a flow rate of intake air, which recirculates and inflows, is further increased, such that a surge line of the compressor ensures a larger operation region, and an operation region is slightly increased even in a chock line due to an increase in flow rate and flow stabilization.

The disclosure has been described in detail with reference to various forms. However, it will be appreciated by those skilled in the art that changes may be made in these forms without departing from the principles and spirit of the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device for variably controlling a flow rate of intake air of a turbocharger compressor, the device comprising:
a compressor housing which guides intake air and discharge air;
a compressor wheel for air intake positioned in the compressor housing;
a sliding insert which is disposed in a straight tube in the compressor housing coaxially with the straight tube, and variably adjusts an intake air recirculation passageway while moving closer to or farther from the straight tube in an axial direction; and
a drive unit which provides power for moving the sliding insert.

2. The device of claim 1, wherein the drive unit includes:
an actuator which generates power;
a rod-lever assembly which is connected to a rod of the actuator and is rotatable; and
a pinion gear which is mounted on the rod-lever assembly and moves the sliding insert.

3. The device of claim 2, wherein the pinion gear of the drive unit is connected to and meshes with a rack gear disposed on the sliding insert and moves the sliding insert by means of a rack-and-pinion mechanism.

4. The device of claim 2, wherein the actuator of the drive unit is configured as a constant-pressure diaphragm type actuator.

5. The device of claim 1, wherein movement of the sliding insert is guided by being in contact with an inner wall of the straight tube by a plurality of guide protrusions formed on an outer circumferential surface of the sliding insert.

6. The device of claim 1, wherein the intake air recirculation passageway, which is resized in accordance with the movement of the sliding insert, is formed in the form of a gap formed between an insert side inclined surface and a straight tube side inclined surface.

7. The device of claim 6, wherein the gap formed between the insert side inclined surface is structured to be inclined from a center of the sliding insert to an outer periphery of the sliding insert toward a front side of the device where intake air inflows, and the straight tube side inclined surface is structured to be inclined from a center of the straight tube to an outer periphery of the straight tube toward the front side of the device where intake air inflows.
